(19) United States
(12) Patent Application Publication
(10) Pub. No.: US 2012/0151396 A1
(43) Pub. Date: Jun. 14, 2012

(54) RENDERING AN OPTIMIZED METRICS TOPOLOGY ON A MONITORING TOOL

(76) Inventors: RAMPRASAD S., Bangalore (IN); Raghavendra D., Bangalore (IN); Chirag Goradia, Mumbai (IN); Vishwas Jamadagni, Bangalore (IN); Dinesh Rao, Bangalore (IN); Suhas S., Bangalore (IN)

(21) Appl. No.: 12/963,647

(22) Filed: Dec. 9, 2010

(51) Int. Cl. G06F 3/048

(52) U.S. Cl. 715/766

(57) ABSTRACT

Various embodiments of systems and methods for rendering an optimized metrics topology on a monitoring tool are described herein. A monitoring tool, installed on a computer, displays a list of monitorable systems and a plurality of components of a system selected from the list. Each component is analyzed under a selected category. Each component includes a set of metrics associated with the selected category. Each metric from the set of metrics for a component is ranked. A rank for each metric is determined based upon at least a navigation behavior of a user of the monitoring tool and a metric characteristic. Based upon their ranks, the metrics are arranged in an optimized metrics topology. Higher ranked metrics are arranged in relatively higher topology level thereby delivering critical or key metrics, up front, in which the user is interested in.

### FIELD

The technical field relates generally to a computer system monitoring tool, and more particularly to presentation of computer system related metrics on the monitoring tool.

### BACKGROUND

System landscape of various organizations includes multiple computer system components that are monitored and maintained by a system administrator. The system administrator employs a monitoring tool (e.g., SAP® solution manager) to analyze the multiple systems from a single system or dashboard. The monitoring tool allows the system administrator to analyze a system and its various components. Each component of the system may be analyzable under various categories, e.g., performance, exceptions, availability, and configuration, etc. Usually, a component is analyzed under a category by analyzing a set of metrics related to the category.

The metrics are preconfigured (grouped) under each category. For example, a dialog response time metric (i.e., amount of time taken to render User Interface) and a user load metric (number of users logged in the system at a given time) are typically grouped under performance category. The metrics are grouped prior to shipping the monitoring tool. Once the monitoring tool is shipped and installed, the system administrator can analyze the metrics grouped under each category. If any fault is indicated relating to any of the metrics, the system administrator takes necessary step(s) to resolve the indicated fault.

The role (work profile) of the system administrator is very dynamic and each system administrator may have their specific work profile. Depending upon the work profile, the system administrator may be interested in analyzing a set of particular metrics related to the category. Sometimes, the system administrator may be only interested in the metrics that are critical or having a problem and require attention. For example, if the performance of a system ‘x’ is deteriorating then the system administrator may be interested in analyzing the critical metrics (metrics having a problem) under the performance category of various components of the system ‘x’. Now, if 100 numbers of metrics are grouped (preconfigured) under the performance category then all of the 100 metrics are rendered on the monitoring tool. The metrics may be rendered randomly or alphabetically. The system administrator scrolls through the metrics to select the critical ones, i.e., the metrics that have problem and require attention.

However, it may be inconvenient for the system administrator to scroll through a large number of preconfigured metrics to select the metrics of their interest (relevant metrics). Further, it would be ineffectual to consider the metrics that are unnecessarily rendered. Additionally, it may be difficult to scroll through the large number of metrics, to select the relevant metrics, each time the system administrator logs-in to the monitoring tool. Also, it would also be impractical to completely remove the metrics that seems non-relevant, as the relevancy of metrics is dynamic and keeps changing with varied usage behavior and system characteristics.

It would be desirable, therefore, to provide a system and method for rendering metrics that obviates the above mentioned problems.

### SUMMARY OF THE INVENTION

Various embodiments of systems and methods for rendering an optimized metrics topology on a monitoring tool are described herein. A monitoring tool is installed on a computer system to receive a user selection of a system from the list of monitorable systems. Based upon the selection, a plurality of components of the system is retrieved. Each component is analyzable under a plurality of categories. A user selection of a component and a category is received. The component includes a set of metrics associated with the selected category. The set of metrics for the component under the selected category is retrieved. Each metric from the set of metrics is ranked. A rank for each metric is determined based upon at least a navigation behavior of the user and a metric characteristic. Based upon their ranks, the metrics are arranged in an optimized metrics topology such that a higher ranked metrics are arranged in relatively higher topology level. The optimized metrics topology is rendered on the monitoring tool. The optimized metrics topology displays the high ranked metrics or critical metrics, up front, in which the user is interested in.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of a system landscape including a monitoring tool for analyzing one or more monitorable system, according to an embodiment of the invention.

FIG. 2A is an exemplary screen display of various components of a monitorable system analyzable under various categories, according to an embodiment of the invention.

FIG. 2B illustrates an exemplary optimized metrics topology displayed on the monitoring tool for a set of metrics of a component under a selected category, according to an embodiment of the invention.

FIG. 3 illustrates an exemplary list of monitorable systems rendered on the monitoring tool, according to an embodiment of the invention.

FIG. 4 is an exemplary screen display of various components of a system and a set of metrics included under a component and a category selected by a user.

FIG. 5 illustrates an exemplary optimized metrics topology displayed on the monitoring tool for the set of metrics illustrated in FIG. 4, according to an embodiment of the invention.

FIG. 6 illustrates another exemplary optimized metrics topology displayed on the monitoring tool for the set of metrics illustrated in FIG. 4, according to another embodiment of the invention.

FIG. 7 is a flow chart illustrating the steps performed to render an optimized metrics topology on a monitoring tool, according to various embodiments of the invention.

FIG. 8 is a block diagram of an exemplary computer system, according to an embodiment of the invention.

### DETAILED DESCRIPTION

Embodiments of techniques for rendering an optimized metrics topology on a monitoring tool are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

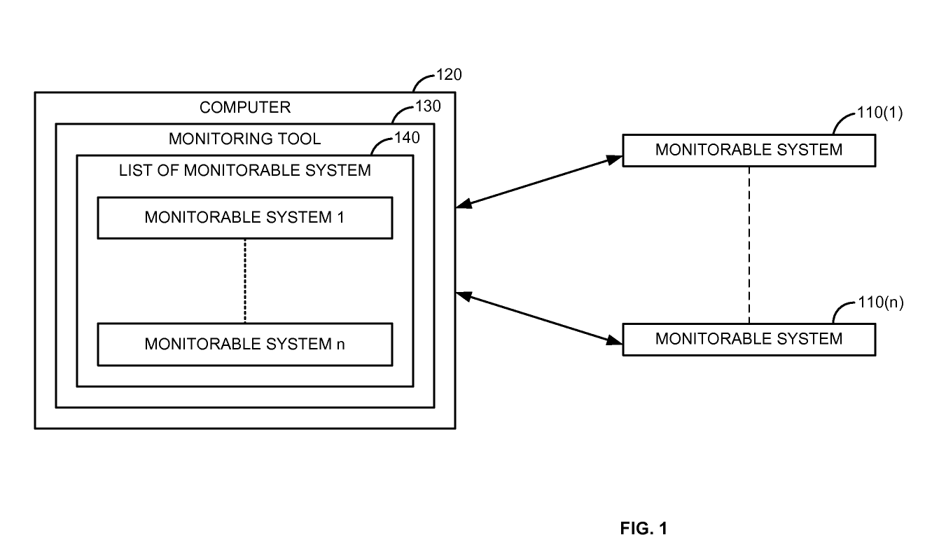

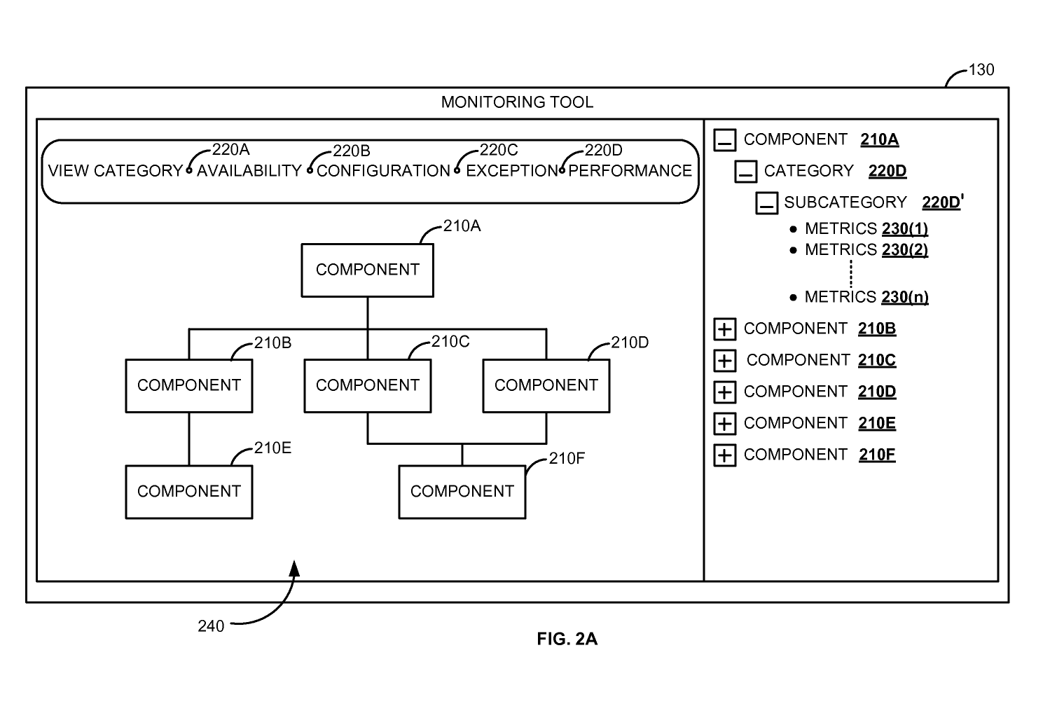

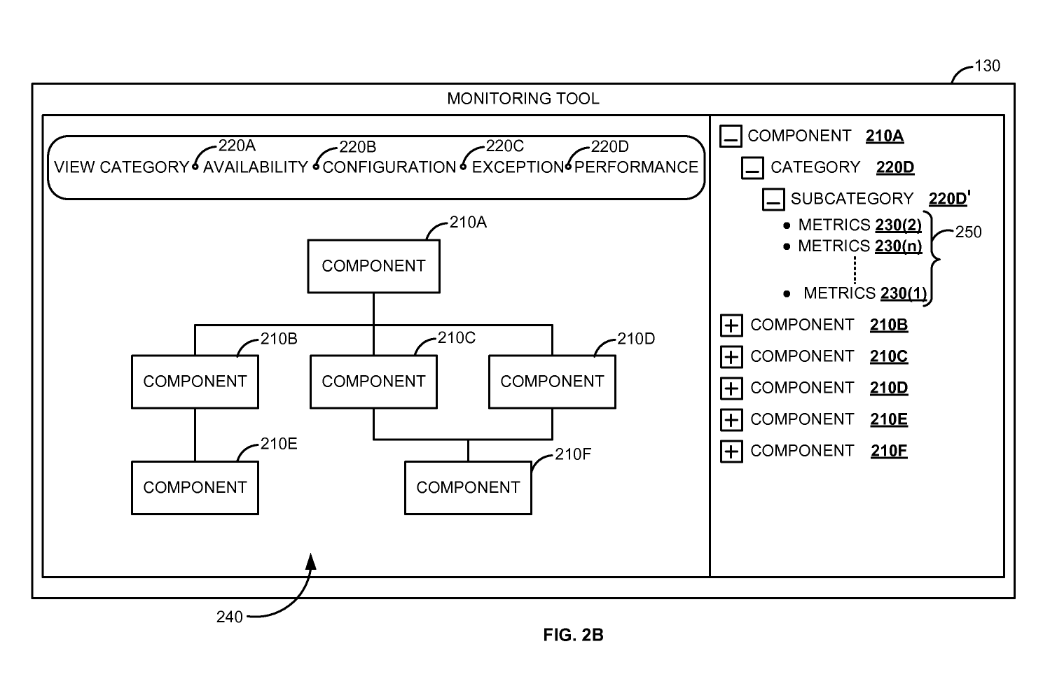

FIGS. 1 and 2A-2C illustrate one embodiment of the invention for analyzing a plurality of monitorable systems 110 (1-n) on a monitoring tool 130 installed on a computer 120. The monitoring tool 130 displays the plurality of monitorable systems 110 (1-n) on a list 140. A user selects a system 110(1) from the list 140. Various components 210 (A-F) (refer FIG. 2A) of the selected system 110(1) are displayed on the monitoring tool 130. Each component is analyzable under a plurality of categories 220 (A-D). The user selects a component 210A and a category 220D under which the component 210A has to be analyzed. The component 210A includes a set of metrics 230 (1-n) associated with the category 220D. Each metric from the set of metrics 230 (1-n) is ranked. In one embodiment, a rank for each metric is determined based upon at least a navigation behavior of the user and a metric characteristic. Based upon their ranks, the metrics 230 (1-n) are arranged in an optimized metrics topology 250 (refer to FIG. 2B). A higher ranked metrics are arranged in relatively higher topology level. The optimized metrics topology 250 is rendered on the monitoring tool 130.

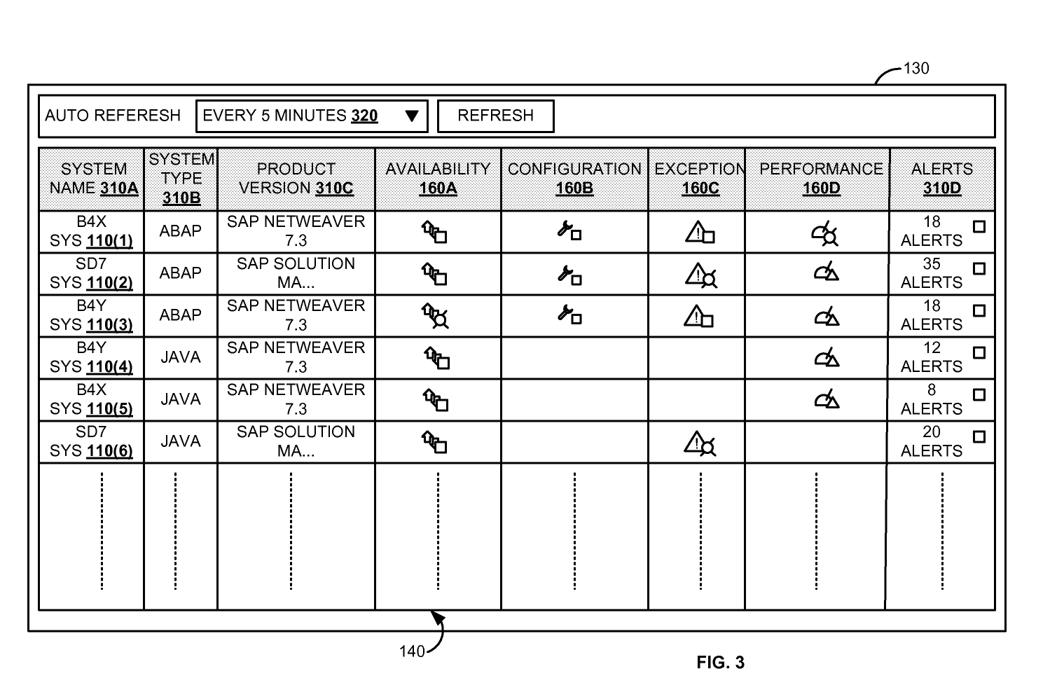

The monitoring tool 130 provides the details of the plurality of monitorable systems 110 (1-n) on the list (list of monitorable systems) 140. The user (e.g., a system administrator) analyzes the list 140 to select the system to be monitored. The list 140 may include various fields for analysis. FIG. 3 illustrates the fields of the list 140 that can be analyzed, e.g., a name of monitorable system (i.e., system name 310A), a type of monitorable system (i.e., system type 310B), a product version of the monitorable system (i.e., product version 310C), total number of alerts triggered for the monitorable system (i.e., alerts 310D), and status related to the plurality of categories, e.g., availability 220A, configuration 220B, exception 220C, and performance 220D. Essentially, the user analyses the alert 310D and the status related to the plurality of categories 220(A-D) to select the system to be monitored.

In one embodiment, each category may be represented by a symbol. The status of the categories 220 (A-D) may be displayed by highlighting their respective symbols with a suitable color. For example, if the performance of the system 110(1) has deteriorated then the symbol indicating performance of the system 110(1) may be highlighted in ‘red’ color. The symbols may be highlighted in ‘green’ color to represent proper/satisfactory status.

The list 140 (including the status of the categories 220 (A-D) and the alerts 310D) is auto updated after a specified period of time 320. The period of time may be specified by the user. The list 140 may also be updated when the user refreshes a screen of the monitoring tool 130. The fields related to the status of the categories 220 (A-D) and the alerts 310D of the list 140 may be analyzed by the user to select the system to be monitored. For example, if the total number of alerts triggered for monitorable system (i.e., alerts 310D) is the highest for a system 110(2) then the user may select the system 110(2) for monitoring. While if the user is interested in monitoring the systems based on the performance 220D then the user may select the system 110(1) as the status of the performance 220D for the system 110(1) is critical or deteriorated (performance 220D symbol) for the system 110(1) is highlighted in ‘red’ color)

Once the system 110(1) is selected, various components 210(A-F) of the system 110(1) are displayed on the monitoring tool 130 (refer to FIG. 2A). The component may be either a software module 210 (A-D) (e.g., an application instance, a database instance, etc) or a hardware module 210 (E-F) (e.g., a host on which the software module(s) runs). The components 210 (A-F) may be displayed in a hierarchical form 240 on a left hand section of the monitoring tool 130, as illustrated in FIG. 2A.

Each component is analyzable under the plurality of the categories 220 (A-D). The category may be selected by the user. Each category may comprise one or more subcategories. For example, the category 220D may includes a subcategory 220D′. The user selects the component and the category/subcategory under which the component has to be analyzed. For example, the user may select the component 210D and the subcategory 220D′ under which the component 210D has to be analyzed. The component 210D includes the set of metrics 230(1-n) under the selected subcategory 220D′.

Each metric of the set of metrics 230 (1-n) is ranked based upon at least any one of a plurality of parameters namely the navigation behavior of the user, the metric characteristic, a technical feature of the system 110(1), an usage of a landscape in which the system 110(1) is installed, a work profile of the system 110(1), and a navigation behavior of other users of the landscape. In one embodiment, the metric is ranked based upon the navigation behavior of the user and the metric characteristic. In another embodiment, the metric is ranked based upon the navigation behavior of the user, the metric characteristic, and at least any one of the technical feature of the system 110(1), the work profile of the system 110(1), the usage of the landscape in which the system 110(1) is installed, and the navigation behavior of other users of the landscape.

According to one embodiment, each of the above mentioned parameters, used in determining the rank, have their respective predefined weightage. The predefined weightage of each parameter is considered in determining the rank of the metric. The predefined weightage may be expressed in terms of percentage (%). The predefined weightage of each parameter is modifiable by the user. The user may increase/decrease the percentage of the predefined weightage of any parameter. For example, if the user is not interested in considering the navigation behavior of the other users for determining the rank, the user may reset the weightage for the navigation behavior of other users as 0%. In one embodiment, the navigation behavior of the user and the metric characteristics are considered in determining the rank and on the scale of 100%, the navigation behavior of the user and the metric characteristic is given the predefined weightage of 50% each. In another embodiment, all the above mentioned parameters are considered in determining the rank and on scale of 100% the weightage for each parameter is distributed as:
navigation behavior of the user: 30%;
navigation behavior of other users: 20%;
metric characteristic: 30%;
technical feature of the system: 10%; and
usage of the landscape: 10%.

According to one embodiment, the navigation behavior of the user is a pattern of viewing the metrics by the user. The navigation behavior of the user may be captured by counting the number of clicks/hits performed on the metric. For instance, two types of hits (clicks) may be performed on the metric:
(i) metric target hit: when the user clicks/hits the metric for performing a task related to the metric or for receiving an information related to the metric the click/hit is called metric target hit. The value of the metric target hit is captured and stored.
(ii) metric hit: when the user clicks the metric for reading or retrieving another metric, underneath it, the click is called metric hit. For example, if a metric “b” is grouped under a metric “a” (“b” is positioned underneath “a”) then the metric “a” may be hit to reach the metric “b” or to read the metric “b.” Such number of clicks/hits performed on the metric “a” to read another metric, underneath it, is termed as metric hit. The value of metric hit is captured and stored.

In one embodiment, at least one of the metric target hit count and the metric hit count is considered in determining the rank of the metric. Essentially, the metric not visited by the user (i.e., having the metric target hit count and the metric hit count=null) is allotted a low rank. The rank of the metric is directly proportional to the metric target hit count and/or the metric hit count. Further, the navigation behaviors of not just the current user but all the other users of the landscape may also be captured and stored for determining the rank of the metric.

According to one embodiment, the metric characteristic is a quantifiable parameter related to the characteristic of the metric. Examples of some parameters may be a trend value of the metric and the total number of alerts triggered for the metric.
(i) trend value of the metric: is captured by analyzing the values of the metric over a specified period of time. In one embodiment, the specified period of time may be last 24 hours. If the values of the metric follows a trend of continuously increasing or continuously decreasing or if there are many fluctuations in the values, over the specified period of time, then the metric is worthy of attention and a high rank would be allotted to the metric. Essentially, a graph is generated by placing time interval on the ‘x’ axis and the value of the metric on the ‘y’ axis. If the graph is continuously increasing or continuously decreasing or if there are many fluctuations in the graph then the metric is allotted a high rank compared to the metric whose graph is constant.
(ii) total number of alerts (one or more alerts) triggered for the metric: the alert is triggered for the metric if the value of the metric crosses a threshold value. The rank of the metric is directly proportional to the total number of alerts triggered for the metric. In one embodiment, the time for which the alert is unresolved is also considered for determining the rank of the metric.

If the weightage of metric characteristic is 30% then the distribution of weightage for the total number of alerts and the trend value of the metric under the metric characteristic may be 20% and 10%, respectively.

According to one embodiment, the technical feature of the system may be captured by storing some information related to technical components of the system, e.g., the information related to a programming language and an operating system. For example, the systems 110 (1-3) employing an ABAP component of SAP®, a dialog response time, update response time, and enqueue utilization, etc., are important metrics that would be given a high rank. Alternatively, for the systems 110(4-6) employing a JAVA component of SAP® the important metrics are a garbage collection time, Http (hypertext transfer protocol) session availability, application threads, system threads that would be given high rank.

According to one embodiment, the work profile of the system is the nature of work for which the system is installed. For example, for a payroll running system background processes related metrics are important (high ranked) whereas, for a CRM (Customer Relationship Management) system (having multiple users login at the same time) a dialog instance metrics and session related metrics are important (high ranked) metrics. The work profile of the system is captured during installation of the monitoring tool 130.

According to one embodiment, the Usage of the landscape is a general work profile of the landscape for which the monitorable systems 110 (1-n) are installed. The information on the usage of the landscape may be retrieved/captured from a landscape directory stored in the computer 120 on which the monitoring tool 130 is installed. For example, a SAP® Netweaver system running HR application of ERP (Enterprise Resource Planning) have different set of important metrics as compared to SAP® Netweaver system running CRM (Customer Relationship Management) and SRM.

Once each metric is ranked, the set of metric 230 (1-n) is arranged in the optimized metrics topology 250. In the optimized metrics topology 250 a higher ranked metric is placed higher in topology level as compared to the lower ranked metrics. For example, the metric 230(2) is the highest ranked metric and is, therefore, placed at the top, the metric 230(n) has rank lower than the metric 230(2) and is, therefore, placed below the metric 230(2), and the metric 230(1) has the lowest rank and is placed at the bottom of the optimized metrics topology 250. Therefore, the metrics 230(1), 230(2), and 230(n) are displayed in the optimized metrics topology 250 in decreasing order of their rank, as illustrated in FIG. 2B. Essentially, the higher ranked metrics are displayed up front compared to the lower ranked metrics.

If the metrics have equal rank the topology level is determined based upon the names of the metrics, i.e., alphabetically. For example, if a metric ‘abc’ and a metric ‘xyz’ both have rank 5 then the metric ‘abc’ is placed on a higher topology level compared to the metric ‘xyz’. In one embodiment, the optimized metrics topology 250 is a list wherein the metrics are arranged in the decreasing order of their rank. If two or more metrics have same rank then they are placed alphabetically in the list.

The optimized metrics topology 250 is rendered on the monitoring tool 130. The optimized metrics topology 250 may be rendered in the same login session or in a subsequent login session. In one embodiment, the optimized metrics topology 250 may be rendered in the same login session automatically or when the user refreshes the screen of the monitoring tool 130. The user may configure the monitoring tool 130 to render only the metrics that have rank above a predefined threshold. The predefined threshold is modifiable by the user. For example, if the user is interested in analyzing only the metrics that have rank above 6 then the user may configure the monitoring tool 130 to render only the metrics having rank above 6.

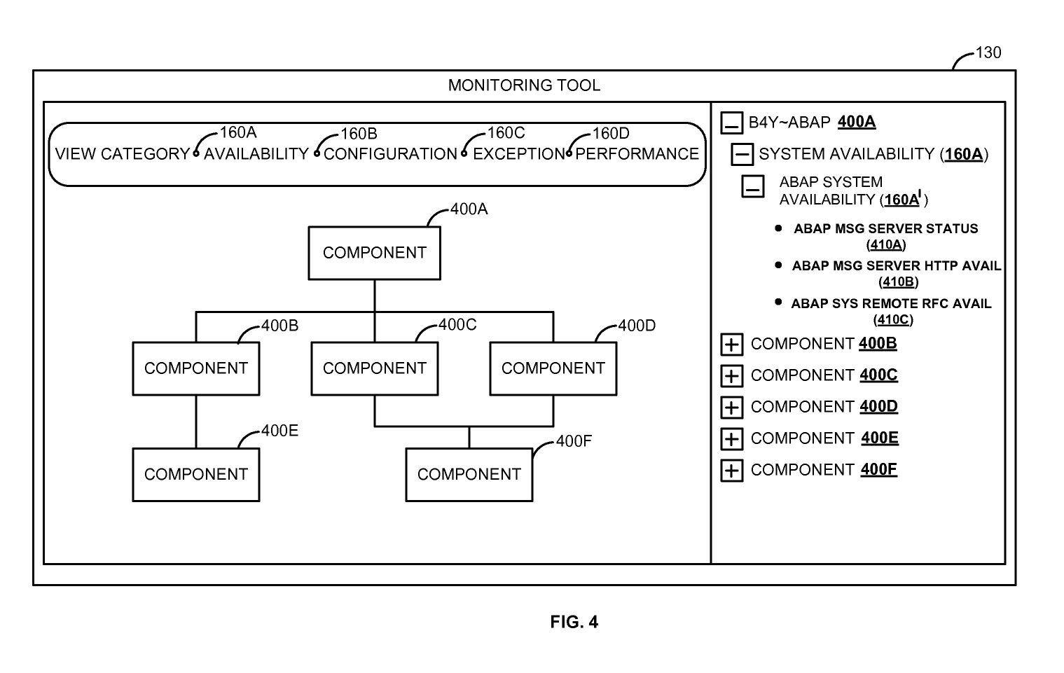

FIG. 4 illustrates an exemplary embodiment showing various components 400 (A-F) of the system 110(3) [system name: B4Y; system type: ABAP] selected by the user for analysis. Essentially, the user analyzes the list 140 for the status of availability 220A. The status of availability 220A for the system 110(3) is critical or poor (availability symbol highlighted in ‘red’). The user then selects the system 110(3) for analysis and the components 400 (A-F) of the system 110(3) is displayed on the monitoring tool 130. The user may analyze each component under the category availability 220A or one or more subcategories under the category availability 220A. For example, the user may select a component 400A [B4X˜ABAP] to be analyzed under the subcategory (ABAP system availability) 220A′ of the category 220A (availability). The component 400A includes the set of metrics 410 (A-C) under the selected subcategory 220A′ (ABAP system availability).

The ABAP system availability 160A′ indicates the availability of the ABAP systems in the system landscape. For example, 160A′ may indicates the ERP system availability. The metric 410A (ABAP message server status) shows the availability of the ABAP message server. The message server is a component within the system that transfers request between application servers. If the ABAP message server status is ‘up’ it indicates that the ABAP message server is available, whereas if the ABAP message server status is ‘down’ it indicates that the ABAP message server is not available, at the moment. The metric 410B (ABAP message server Http available) indicates if the Http port of the ABAP message server is available or not. If the Http port is available, the message server provides the list of instances which are available through the Http response. The metric 410C (ABAP system remote RFC (Remote Function Calls) available) shows the availability of the ABAP system remote RFC. The RFC protocol enables two ABAP systems to communicate.

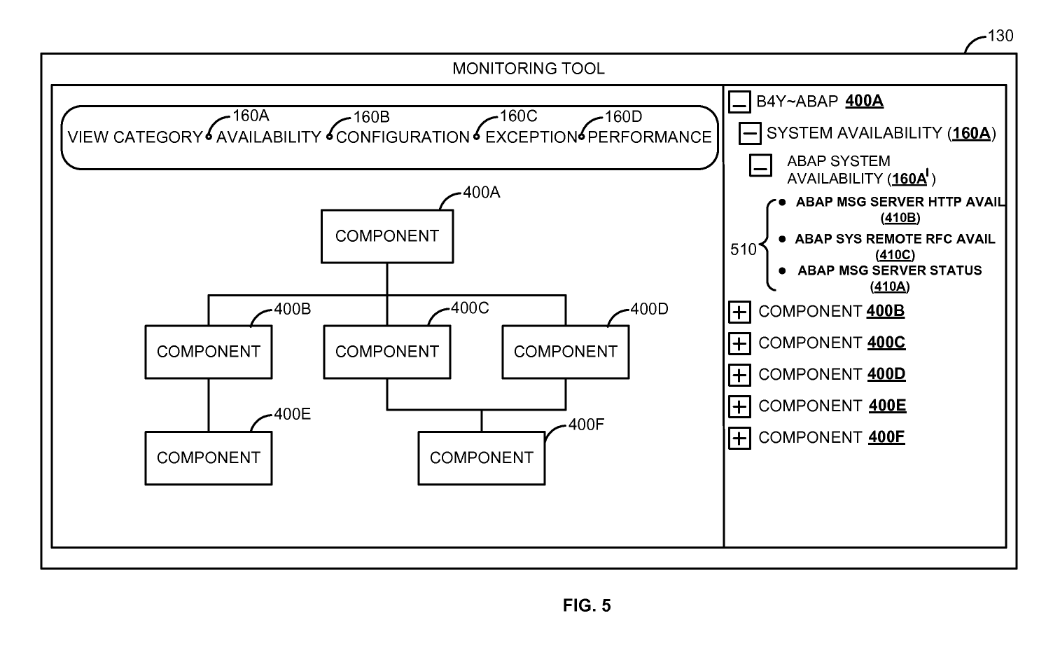

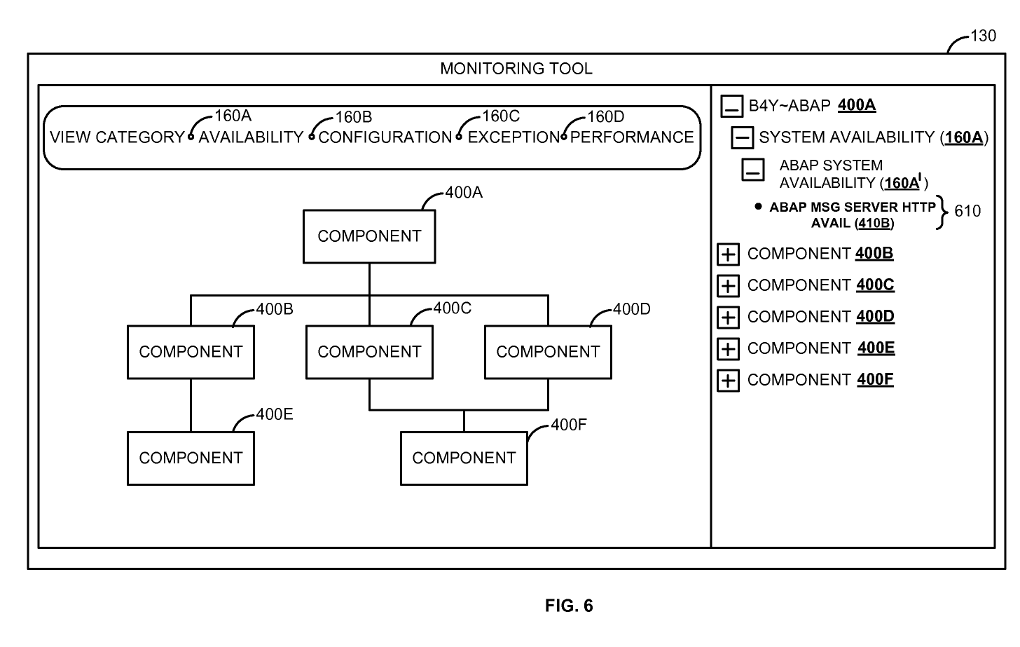

Each metric of the set of metrics 410 (A-C) is ranked based upon the navigation behavior of the user and the metric characteristic. Once each metric is ranked, the set of metric 410 (A-C) is arranged in the optimized metrics topology 510 (refer to FIG. 5). In the optimized metrics topology 510 a higher ranked metric is placed in a higher topology level as compared to the lower ranked metrics. For example, the metric 410B (ABAP message server Http available) is the highest ranked metric and is, therefore, placed at the top, the metric 410C (ABAP system remote RFC available) has rank lower than the metric 410B and is, therefore, placed below the metric 410B, and the metric 410A (ABAP message server status) has the lowest rank and is placed at the bottom of the optimized metrics topology 510. Therefore, the metrics 410A, 410B, and 410C are displayed in the optimized metrics topology 510 in decreasing order of their rank, as illustrated in FIG. 4. Essentially, the higher ranked metrics are displayed up front compared to the lower ranked metrics. The optimized metrics topology 510 is rendered on the monitoring tool 130. In one embodiment, the optimized metrics topology includes only the metrics having rank above the predefined threshold. For example, if the rank of the metrics 410A, 410B, and 410C are 5, 7, and 6, respectively, and the predefined threshold is 6 then only the metric 410B, having rank above the predefined threshold (i.e., rank=7), is displayed in the optimized metrics topology 610, as illustrated in FIG. 6.

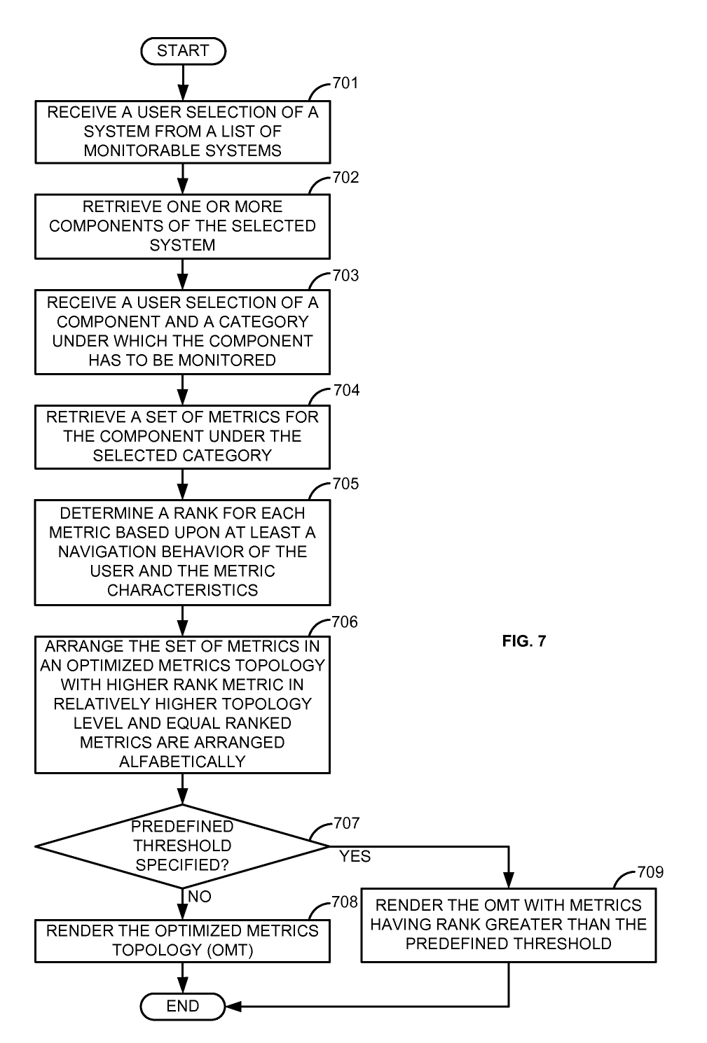

FIG. 7 is a flowchart illustrating a method for rendering the optimized metrics topology 250 on the monitoring tool 130. The monitoring tool 130 displays the list of monitorable systems 140 for the user's selection. The list 140 includes status related to various categories, e.g., availability 220A, configuration 220B, exception 220C, and performance 220D. The user may make selection of the system 110(1) based upon the status of the category of the user's interest. The monitoring tool 130 receives the user selection of the system 110(1) at step 701. Based upon the selection, the plurality of the components 210 (A-F) of the system 110(1) is retrieved at step 702. Various categories 220 (A-D) and/or subcategories are displayed on the monitoring tool 130. The user can make selection for the category 220D. The monitoring tool 130 receives the user selection of the component 210(A) and the category 220D at step 703. The monitoring tool 130 retrieves the set of metrics 230 (1-n) for the component 210(A), under the selected category 220D at step 704. The rank for each metric from the set of metrics 230 (1-n) is determined based upon at least the navigation behavior of the user and the metric characteristic at step 705. The set of metrics 230 (1-n) are arranged in the optimized metrics topology 250 with the high ranked metrics in relatively higher topology level and equal ranked metrics are arranged alphabetically at step 706. The monitoring tool 130 checks if the predefined threshold is specified at step 707. If the predefined threshold is not specified (step 707: NO), the optimized metrics topology 250 is rendered on the user interface at step 708. If the predefined threshold is specified (step 707: YES), the optimized metrics topology 250 with metrics having rank greater than the predefined threshold is rendered on the user interface at step 709.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

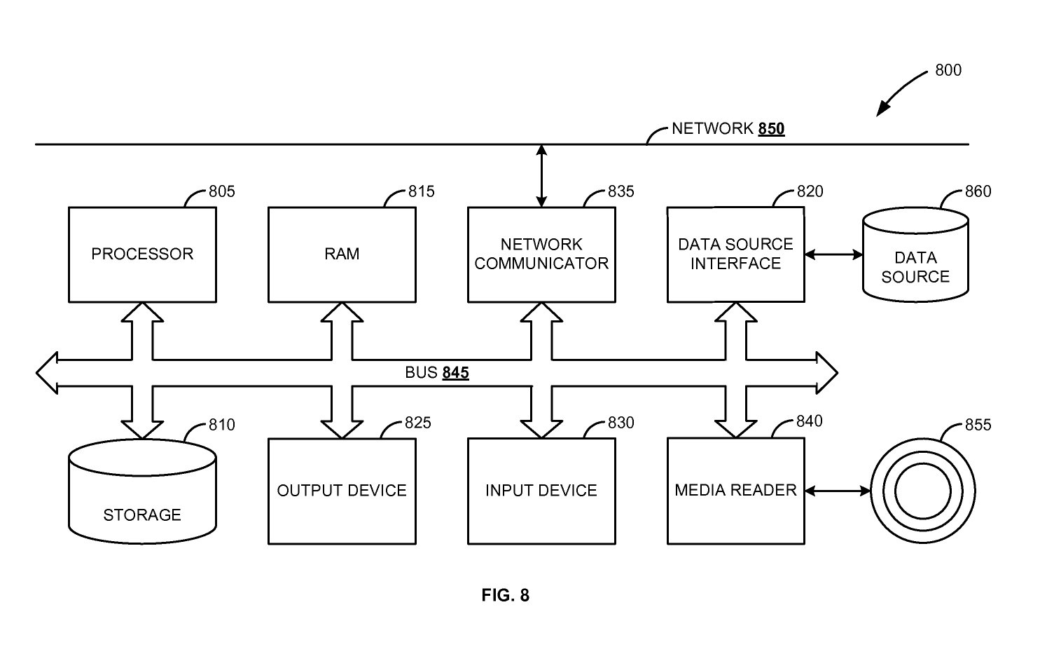

FIG. 8 is a block diagram of an exemplary computer system 800. The computer system 800 includes a processor 805 that executes software instructions or code stored on a computer readable storage medium 855 to perform the above-illustrated methods of the invention. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
receive a user selection of a system from a list of monitorable systems;
based upon the selection, retrieve a plurality of components of the system;
receive a user selection of a category from a plurality of categories;
retrieve a set of metrics for a component under the selected category;
determine a rank for each metric from the set of metrics based upon at least a navigation behavior of the user and a metric characteristic;
arrange the set of metrics in an optimized metrics topology based upon their respective rank, wherein higher ranked metrics are arranged in relatively higher topology level; and
render the optimized metrics topology on a user interface.

2. The article of manufacture of claim 1, wherein the category comprises performance, availability, exception, and configuration of the system.

3. The article of manufacture of claim 1, wherein the navigation behavior of the user includes at least one of:
a metric hit count, wherein the metric hit count is a number of times the metric is clicked on for reaching another metric; and
a metric target hit count, wherein the metric target hit count is a number of times the metric is clicked on for receiving the metric specific information.

4. The article of manufacture of claim 1, wherein the metric characteristic comprises one or more alerts triggered for the metric and numerical values of the metric recorded over a specified period of time.

5. The article of manufacture of claim 1, wherein the navigation behavior of the user and the metric characteristic have respective predefined weightage that are considered in determining the rank.

6. The article of manufacture of claim 5, wherein each of the predefined weightage is modifiable by the user.

7. The article of manufacture of claim 1, wherein the rank is determined further based upon at least one of the following parameters:
a business role of the user;
a technical feature of the system;
a work profile of the system;
usage of a landscape in which the system is installed; and
a navigation behavior of other users of the landscape.

8. The article of manufacture of claim 7, wherein each parameter has a respective predefined weightage that is considered in determining the rank and wherein the predefined weightage is modifiable by the user.

9. The article of manufacture of claim 1, wherein the metrics having equal rank are arranged alphabetically in the optimized metrics topology.

10. The article of manufacture of claim 1, wherein the optimized metrics topology includes the metrics having the rank above a predefined threshold.

11. The article of manufacture of claim 10, wherein the predefined threshold is modifiable by the user.

12. The article of manufacture of claim 1, wherein the list of monitorable systems includes names, number of alerts, and status related to at least one of availability, performance, exception, and configuration for each of the monitorable system and wherein the list of monitorable systems is auto updated after a specified period of time.

13. The article of manufacture of claim 1, wherein the category includes a subcategory and wherein the set of metrics is retrieved for the component under the subcategory selected by the user.

14. A computerized method for rendering optimized metrics topology, the method comprising:
receiving a user selection of a system from a list of monitorable systems;
retrieving a plurality of components of the system selected by the user;
receiving a user selection of a category from a plurality of categories;
retrieving a set of metrics for a component under the selected category;
determining a rank for each of the metric of the set of metrics based upon at least a navigation behavior of a user and a metric characteristic;
arranging the set of metrics in the optimized metrics topology based upon their respective rank, wherein a higher ranked metrics are arranged in relatively higher topology level; and
rendering the optimized metrics topology on a user interface.

15. The method of claim 14 further comprising determining the navigation behavior of the user by performing at least one of the following:
capturing a number of times the metric is clicked on for reaching another metric; and
capturing a number of times the metric is clicked on for receiving the metric specific information.

16. The method of claim 14, wherein rendering the optimized metrics topology to the user further comprising rendering the metrics having rank greater than a predefined threshold.

17. The method of claim 14 further comprising rendering the metrics having equal rank alphabetically in the optimized metrics topology.

18. A computer system for rendering an optimized metrics topology, comprising:
a memory to store a program code;
a processor communicatively coupled to the memory, the processor configured to execute the program code to:
receive a user selection of a system from a list of monitorable systems;
based upon the selection, retrieve a plurality of components of the system;
receive a user selection of a category from a plurality of categories;
retrieve a set of metrics for a component under the selected category;
determine a rank for each of the plurality of metrics based upon at least a navigation behavior of a user and a metric characteristic; and
arrange the metrics in the optimized metric topology based upon their respective rank, wherein a higher ranked metrics are arranged in relatively higher topology level;
and
a user interface device for rendering the optimized metrics topology.

19. The computer system of claim 18, wherein the processor is further configured to determine at least one of the followings:
a metric hit count, wherein the metric hit count is a number of times the metric is clicked on for reaching another metric;
a metric target hit count, wherein the metric target hit count is a number of times the metric is clicked on for performing the metric specific task or for receiving the metric specific information;
number of alerts triggered for the metric; and
numerical values of the metric recorded over a specified period of time.

20. The computer system of claim 18 further comprising a database configured to store information related to technical feature of monitorable systems, wherein the technical feature includes operating system information and programming language information.
